(19) United States
(12) Patent Application Publication
(10) Pub. No.: US 2010/0166263 A1
(43) Pub. Date: Jul. 1, 2010

(54) ELECTRONIC DEVICE AND MEASURING METHOD USING THE SAME

(75) Inventors: SHUAI CAO, Shenzhen City (CN); JING-BO YU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISON INDUSTRY (ShenZhen) CO., LTD., Shenzhen City (CN); HON HAI PRECISION INDUSTRY CO., LTD., Tu-Cheng (TW)

(21) Appl. No.: 12/647,389

(22) Filed: Dec. 24, 2009

(30) Foreign Application Priority Data
Dec. 30, 2008 (CN) 200810306681.9

(51) Int. Cl. G06K 9/00; G06F 3/041

(52) U.S. Cl. 382/106; 345/173

(57) ABSTRACT

An electronic device includes an image capturing device, a touch sensitive display, a distance measuring device, and a processor. The image capturing device picks up an image of the object and determining a focal length of the image capturing device at which the image capturing device captures the image. The touch sensitive display displays the image and receives input touches on the image to determine a touching region. The distance measuring device determines a distance between the electronic device and the object. The processor extracts the dimension of the touching region to determine the dimension of the image of the object, and determines the dimension of the object based on the dimension of the image of the object, the distance, and a pre-setting proportional relationship about the dimension of the image of the object, the distance between the electronic device and the object, and the focal length.

### BACKGROUND

1. Technical Field

The present disclosure relates to electronic devices, and particularly to an electronic measuring device.

2. Description of Related Art

Generally, to measure the dimension of an object, the measurements are always performed by using measuring instruments, such as rulers and tapes. When a ruler is used for such measurements, the person must approach the object to be measured, and place the ruler next to the object to take measurements. The use of a tape also requires the same approach. In many cases, to approach an object is inconvenient, for instance, the measured object may lie in a location inconvenient for the person taking the measurement to approach.

Therefore, an electronic device and a measuring method using the electronic device for measuring conveniently are desired.

### BRIEF DESCRIPTION OF THE DRAWINGS

Many aspects of the embodiments can be better understood with reference to the following drawing. The components in the drawing are not necessarily drawn to scale, the emphasis instead being placed upon clearly illustrating the principles of the present embodiments.

FIG. 1 is a functional block diagram of an electronic device for measuring the dimension of an object in accordance with an exemplary embodiment.

FIG. 2 illustrates an image of an object.

FIG. 3 illustrates a process of measuring the image shown in FIG. 2.

FIG. 4 is a flowchart of a measuring method in accordance with an exemplary embodiment.

### DETAILED DESCRIPTION

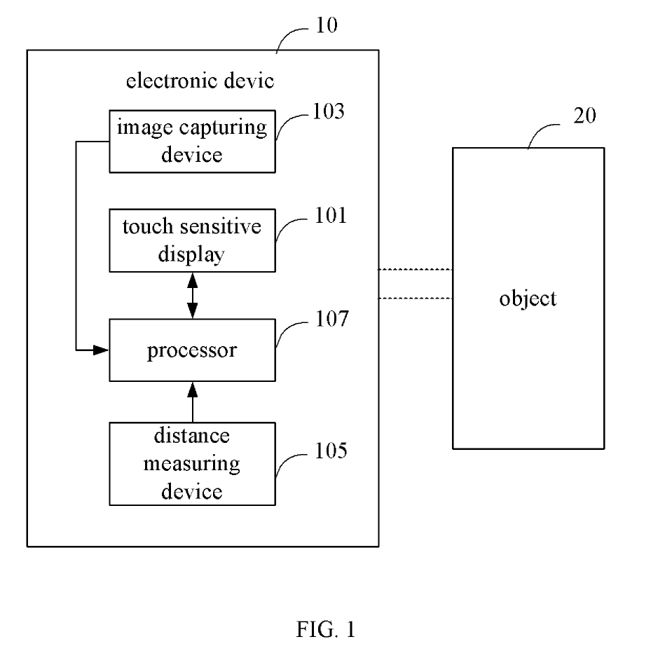

Referring to FIG. 1, an electronic device 10 capable of measuring the dimension of an object 20 is shown in accordance with an exemplary embodiment. The electronic device 10 may be a mobile phone, a notebook computer, a personal digital assistant (PDA), etc. The dimension may be a length, a width, a height, and an area of the object 20. The electronic device 10 includes an image capturing device 103, a touch sensitive display 101, a distance measuring device 105, and a processor 107.

The image capturing device 103 may be a digital camera. The image capturing device 103 is configured to capture an image of the object 20 by automatically focusing on the object 20 and to determine the focal length. How a digital camera determines the focal length is well known, so in this embodiment it will not be described with details. The touch sensitive display 101 is configured to represent the image produced by the image capturing device 103. The touch sensitive display 101 is also capable of generating a user input selection on the touch sensitive display 101. For example, when the user draws a circle on the touch sensitive display 101, the touch sensitive display 101 generates and displays the circle. When the user draws a line, the touch sensitive display 101 generates and displays the line. Likewise, when the user draws a plurality of lines forming a polygon, the touch sensitive display 101 generates the polygon and displays it. In this embodiment, the user is desired to draw a contour line of the image of the object 20. The touch sensitive display 101 generates the touching region which is formed by the contour line of the image of the object 20, such that dimension of the image of the object 20 can be extracted.

The distance measuring device 105 is configured to measure the distance L between the image capturing device 103 and the object 20. Understandably, the distance L is the object distance of the image capturing device 103. The distance measuring device 105 may perform its measurement using an infrared, an ultrasonic, or a laser. For example, the distance measuring device 105 uses the infrared. Firstly, the distance measuring device 105 emits and projects an infrared light on the object 20. Secondly, the distance measuring device 105 receives a reflected infrared light from the object 20. Thirdly, the distance measuring device 105 calculates the interval between a projecting time of the infrared and a receiving time of the reflected infrared, and then determines the distance L between the electronic device 10 and the object 20 based on the transmitting speed of the infrared and the interval. The distance L is used for determining a ratio of an actual size of the object 20 to the image size of the object 20. How to determine the ratio will be described below.

The processor 107 is firstly configured to analyze the touching region generated by the touch sensitive display 101 to determine the dimension of the image of the object 20, such as length, and width. For example, the processor 107 calculates the dimension of image of the object 20 by analyzing length and width of the touching region about the X-axis and the Y-axis defined in the touch sensitive display 101.

The processor 107 is secondly configured to determine actual dimension of the object 20 based on the dimension of the image of the object 20, the distance L and a pre-setting proportional relationships about the dimension of the image of the object 20, the distance L, and the focal length. In this embodiment, the pre-setting proportional relationships are defined as following:

R(s)=So/Si=U²/V² R(1)=Lo/Li=U/V expression(1)

1/U+1/V=1/F expression(2)

R(s) is the ratio of the area So of the object 20 to the area Si of the image of the object 20. R(1) is the ratio of the length/width Lo of the object 20 to the length/width Li of the image of the object 20. The U is the object distance which is the distance L between the electronic device 10 and the object 20. The U can be calculated by the distance measuring device 105. The F is the focal length which can be calculated by the image capturing device 103. The V is the image distance. The processor 107 first determines the image distance based on the distance L and the focal length of the image capturing device 103 according to expression (2) shown above. The processor 107 secondly determines a ratio of the dimension of the object 20 to the dimension of the image of the object 20, such as the ratio of area and the ratio of length/width/height based on the distance L and the image distance according to the expression (1). The processor 107 thirdly determines the dimension of the object 20 and the ratio according to the expression (1).

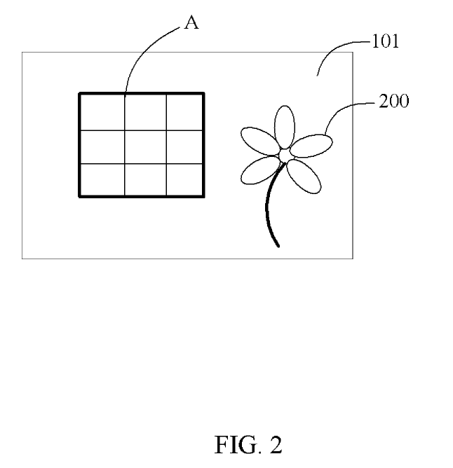

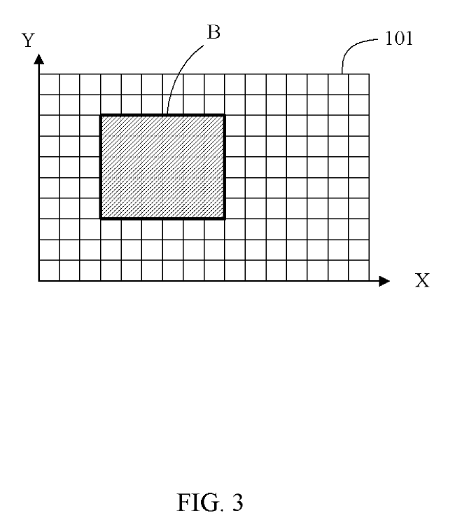

Referring to FIG. 2 and FIG. 3, a description is given to explain how the dimension of the object 20 derived from an image 200 of the object 20 shown on the FIG. 2. In this embodiment, the object 20 is a rectangle.

In FIG. 2, the image 200 displayed on the touch sensitive display 101 is the image of the object 20 produced by the image capturing device 103. A frontal orthogonal view of the object 20 is picked up as in the image 200 which appears as a rectangle A. In FIG. 3, to obtain the dimension of the object 20, a silhouette is drawn around the rectangle A, the touch sensitive display 101 generates a rectangle by the user touching or outlining region B. The processor 107 then determines dimension of the touching region B, such as length, width, and area. After that, the processor 107 determines the actual physical properties of the object 20 based on the image properties of the touching region B, the distance L, and the pre-setting proportional relationships, and displays the dimension of the object 20 via the touch sensitive display 101.

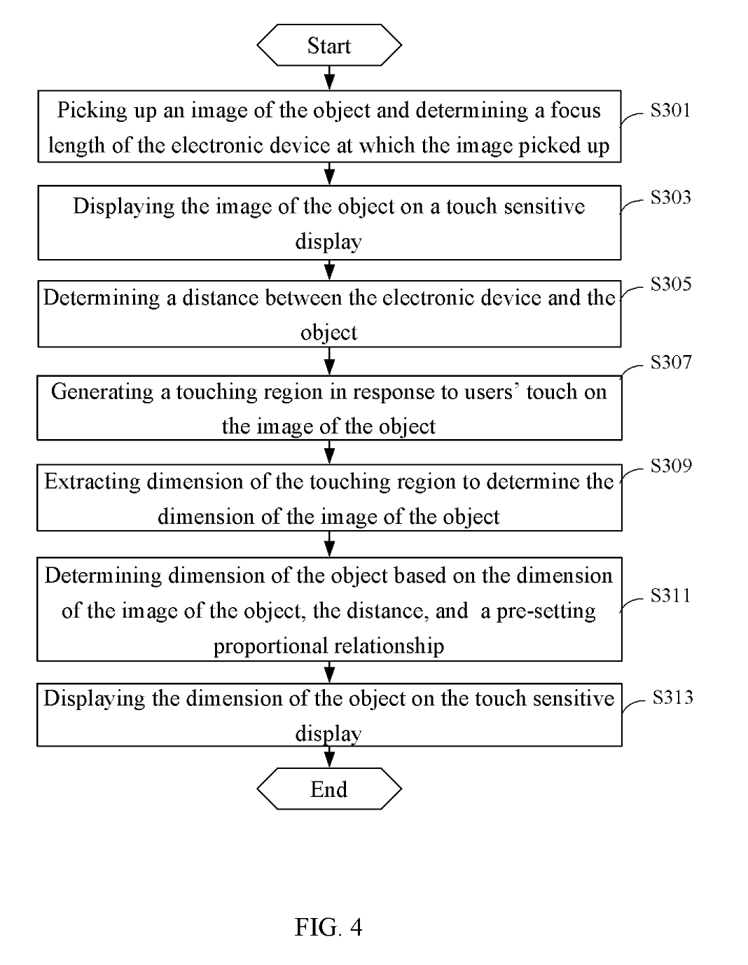

Referring to FIG. 4, the method implemented in an electronic device for determining the dimension of an object includes following steps:

In step S301, picking up an image of the object and determining a focal length of the electronic device at which the image is picked up. The image of the object can be picked up by a digital camera configured in the electronic device. The digital camera can automatically focus on the object to determine the focal length.

In step S303, displaying the image of the object on a touch sensitive display.

In step S305, determining a distance between the electronic device and the object. For example, determining the distance can be performed by a distance measuring device configured in the electronic device. The distance measuring device performs its measurement by projecting an infrared light to the object, receiving the reflected infrared light, and determining the distance based on the interval between the projecting time of the infrared light and the receiving time of the reflected infrared light, and the speed of the infrared light. In another embodiment, the distance measuring device performs its measurement using an ultrasonic or a laser.

In step S307, generating a touching region in response to users' touch on the image of the object. For example, the user draws contour lines of the image of the object present on the touch sensitive display, the touch sensitive display generates the touching region which forming by the contour lines of the image of the object.

In step S309, extracting dimension of the touching region to determine the dimension of the image of the object. The dimension indicating size of the object includes length, width, and area and so on. For example, extracting the dimension of the touching region can be performed by analyzing the length, width of the touching region about the X-axis and the Y-axis defined in the touch sensitive display.

In step S311, determining dimension of the object based on the dimension of the image of the object, the distance, and a pre-setting proportional relationship about the dimension of the image of the object, the distance, and the focal length. Firstly, determining the image distance of the electronic device based on the distance between the electronic device and the object, and the focal length according to the pre-setting proportional relationship. Secondly, determining the ratio of the dimension of the object to the dimension of the image of the object based on the distance between the electronic device and the object, and the image distance according to the proportional relationship. Thirdly, determining the dimension of the object based on the dimension of the image of the object and the ratio according to the proportional relationship.

In step S313, displaying the dimension of the object on the touch sensitive display.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device capable of measuring dimension of an object, the electronic device comprising:
an image capturing device configured to pick up an image of the object and determining a focal length of the image capturing device at which the image capturing device captures the image;
a touch sensitive display configured to display the image picked up by the image capturing device and receive touch inputs on the image to determine a touching region;
a distance measuring device configured to determine a distance between the electronic device and the object; and
a processor configured to extract the dimension of the touching region to determine the dimension of the image of the object, and determine the dimension of the object based on the dimension of the image of the object, the distance, and a pre-setting proportional relationship about the dimension of the image of the object, the distance, and the focal length.

2. The electronic device of claim 1, wherein the touch sensitive display further displays the dimension of the object.

3. The electronic device of claim 1, wherein the dimension of the touching region is extracted by analyzing the touching region about the axes defined in the touch sensitive display.

4. The electronic device of claim 1, wherein the distance measuring device performs its measurement by selectively using one of an infrared, an ultrasonic, and a laser.

5. The electronic device of claim 1, wherein the processor determines the dimension of the object by determining the image distance based on the distance and the focal length of the image capturing device; determining a ratio of the object to the dimension of the image of the object based on the distance and the image distance; determining the dimension of the object based on the ratio and the dimension of the image of the object.

6. A method for controlling an electronic device to measure dimension of an object, the method comprising:
picking up an image of the object and determining a focal length of the electronic device at which the image is picked up;
displaying the image on a touch sensitive display of the electronic device;
determining a distance between the electronic device and the object;
generating a touching region in response to users' touch inputs on the image of the object;
extracting the dimension of the touching region to determine the dimension of the image of the object; and determining the dimension of the object based on the dimension of the image of the object, the distance, a pre-setting proportional relationship about the dimension of touching region, the dimension of the object, the distance between the electronic device and the object, and the focal length.

7. The method of claim 6, further comprising displaying the dimension of the object.

8. The method of claim 6, wherein determining the distance between the electronic device and the object is performed by selectively using one of an infrared, an ultrasonic and a laser.

9. The method of claim 6, wherein determining dimension of the object comprises following steps: determining the image distance of the electronic device based on the distance between the electronic device and the object, and the focal length according to the pre-setting proportional relationship; determining the ratio of the dimension of the object to the dimensions of image of the object based on the distance between the electronic device and the object, and the image distance according to the proportional relationship; and determining the dimension of the object based on the dimension of the image of the object and the ratio according to the proportional relationship.

10. The method of claim 6, wherein the dimension of the touching region is extracted by analyzing the touching region about the axes defined in the touch sensitive display.
